(19) United States
(12) Patent Application Publication
(10) Pub. No.: US 2007/0202444 A1
(43) Pub. Date: Aug. 30, 2007

(54) Resist pattern forming method and apparatus

(75) Inventors: Yoshikatsu Shimoda, Kawasaki (JP); Hajime Yamamoto, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/505,441

(22) Filed: Aug. 17, 2006

(30) Foreign Application Priority Data
Feb. 28, 2006 (JP) 2006-052617

(51) Int. Cl. G03C 5/00

(52) U.S. Cl. 430/311

(57) ABSTRACT

A resist pattern forming method which uses resist pattern swelling technique and yet is capable of reducing CD dispersion. A resist pattern is formed on a substrate, and the substrate is left to stand or is baked. Subsequently, the substrate is applied with a swelling agent and then baked. After the baking, the swelling agent is peeled off, thus obtaining a swollen resist pattern. Thus, the substrate having the resist pattern formed thereon is left to stand or is baked before applied with the swelling agent, whereby a mutual solution layer can be formed uniformly between the resist pattern and the swelling agent. This permits the formation of resist patterns reduced in CD dispersion.

### CROSS-REFERENCE TO RELATED APPLICATIONS

This application is based upon and claims the benefits of priority from the prior Japanese Patent Application No. 2006-052617, filed on Feb. 28, 2006, the entire contents of which are incorporated herein by reference.

### BACKGROUND OF THE INVENTION

1. Field of the Invention

The present invention relates to resist pattern forming method and apparatus, and more particularly, to resist pattern forming method and apparatus which use a resist pattern swelling technique and yet can reduce dispersion of CD (Critical Dimension; minimum line width).

2. Description of the Related Art

To form resist patterns in the process of fabrication of semiconductor integrated circuits, photolithography is used because of its high productivity.

As a light source for exposing photoresist in photolithography, KrF (krypton fluoride) excimer light (wavelength: 248 nm) has hitherto been used for the formation of nodes of the order of 130 nm. Recently, however, shorter-wavelength ArF (argon fluoride) excimer light (wavelength: 193 nm) has begun to be used to form nodes of 100 nm or less.

The photoresist technique using ArF excimer light cannot be applied to resist materials that have been employed in the photoresist technique using KrF excimer light, for example, novolak resins. Novolak resin has an aromatic ring in its molecular chain, and this kind of resist shows high absorptance of far ultraviolet rays (e.g., of the wavelength 193 nm). Thus, when far ultraviolet rays are irradiated onto the surface of the resist, photochemical reaction takes place near the surface of the resist, hindering the penetration of the rays in the film thickness direction. Consequently, where ArF excimer light is used as the light for exposing novolak resin, for example, a problem arises in that a region beneath the surface of the resin in the film thickness direction fails to be resolved.

To solve the problem, resist materials capable of satisfactorily transmitting far ultraviolet rays have been developed, such as adamantane-based resists and COMA (cycloolefin/maleic anhydride copolymer)-based resists. With these resists, it is possible to form nodes of 100 nm or less through the exposure to ArF excimer light.

Meanwhile, resist pattern swelling is known as a technique for obtaining a resist pattern exceeding the exposure limit. According to this technique, a resist pattern is previously formed with precision close to the exposure limit, and a resist swelling agent that reacts with the resist is applied onto the resist pattern. Then, the resist is allowed to swell through the reaction with the resist swelling agent, thereby reducing the dimensions of the resist pattern beyond the exposure limit.

A typical example of the swelling techniques is RELACS (Resolution Enhancement Lithography Assisted by Chemical Shrink) developed for resists for use with KrF excimer light (e.g., Unexamined Japanese Patent Publication No. H10-73927). An improved swelling technique adapted for resists for use with ArF excimer light has also been proposed (e.g., Japanese Patent No. 3633595).

According to the improved technique adapted for resists for use with ArF excimer light, a film serving as a swelling agent is coated on the resist pattern to improve the affinity between the swelling agent and the resist at their interface. Thus, even in the case of a resist for use with ArF excimer light, it is possible to form a resist pattern satisfactorily exceeding the exposure limit. Namely, the resist pattern and the swelling film are made to dissolve in each other, thereby swelling the resist.

In this swelling technique, the steps shown in FIG. 11 are followed to swell the resist pattern. FIG. 11 illustrates an exemplary resist pattern swelling process. First, a resist for use with ArF excimer light is applied onto a substrate (Step S10). Subsequently, the substrate is pre-baked (Step S11), and the resist is irradiated with ArF excimer light through a pattern mask for exposure (Step S12). The substrate is then post-baked (Step S13) and is developed to form a resist pattern (Step S14). Then, the substrate is applied with a swelling agent (Step S15) and is baked to swell the resist (Step S16). Finally, the applied swelling agent is peeled off (Step S17), thus obtaining a swollen resist pattern.

The resist pattern swelling technique illustrated in FIG. 11 is, however, associated with the problem that layers (hereinafter referred to as mutual solution layers) formed at the interface between the mutually soluble resist pattern and swelling agent significantly vary in thickness etc., which results in dispersion of CD after the swelling.

CD dispersion poses a more serious problem where smaller nodes are to be formed, because the ratio of CD dispersion to design pattern increases with increase in fineness of the design pattern.

### SUMMARY OF THE INVENTION

The present invention was created in view of the above circumstances, and an object thereof is to provide resist pattern forming method and apparatus whereby CD dispersion can be reduced even though resist patterns are swollen.

To achieve the object, there is provided a resist pattern forming method comprising the step of applying a resist onto a substrate, the step of forming a resist pattern out of the resist, the step of stabilizing surface condition of the resist pattern, the step of applying a swelling agent onto the stabilized resist pattern, and the step of swelling the resist pattern by using the swelling agent.

Also, to achieve the above object, there is provided a resist pattern forming apparatus comprising a unit for applying a resist onto a substrate, a unit for forming a resist pattern out of the resist, a unit for stabilizing surface condition of the resist pattern, a unit for applying a swelling agent onto the stabilized resist pattern, and a unit for swelling the resist pattern by using the swelling agent.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 exemplifies a resist pattern swelling process flow.

FIG. 2 shows an exemplary configuration of a resist pattern forming apparatus.

FIG. 3 is a sectional view showing a principal part in a resist application step.

FIG. 4 is a sectional view showing the principal part in an exposure/developing step.

FIG. 5 is a sectional view showing the principal part in a storage step.

FIG. 6 is a sectional view showing the principal part in a film coating step.

FIG. 7 is a sectional view showing the principal part in a swelling step.

FIG. 8 is a sectional view showing the principal part in a coating peeling step.

FIG. 9 shows CD variations of individual substrates.

FIG. 10 shows CD variation rates and 3σ values.

FIG. 11 shows an exemplary resist pattern swelling process.

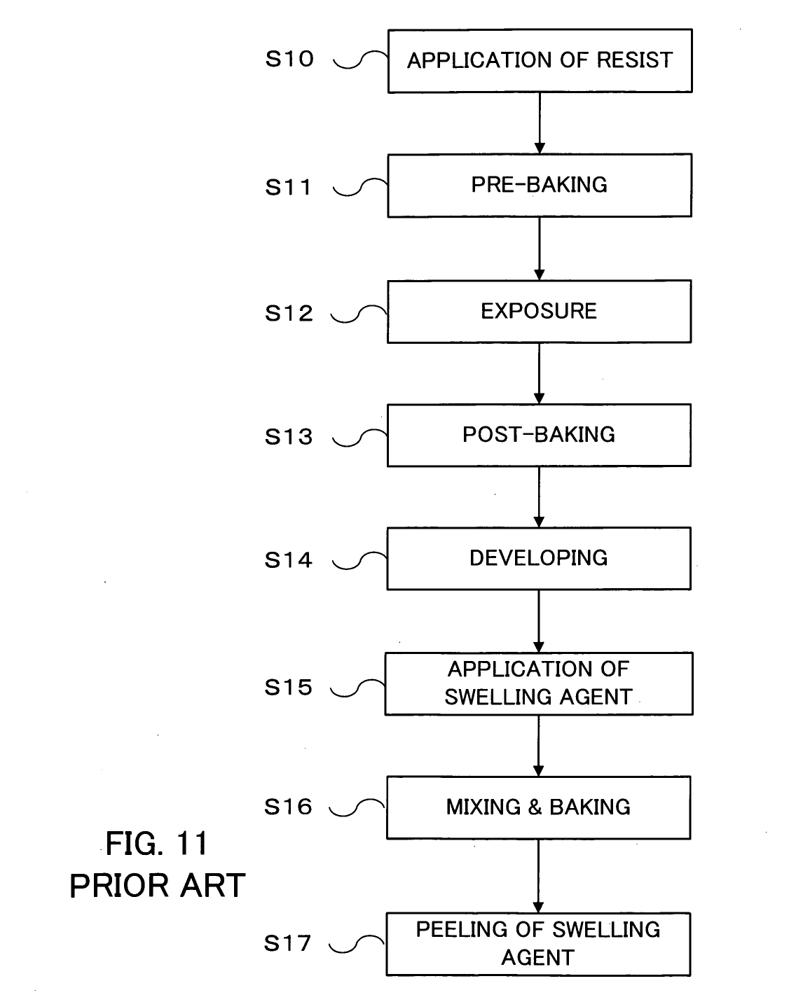

### DESCRIPTION OF THE PREFERRED EMBODIMENTS

Preferred embodiments of the present invention will be described below with reference to the accompanying drawings, wherein like reference numerals refer to like elements throughout.

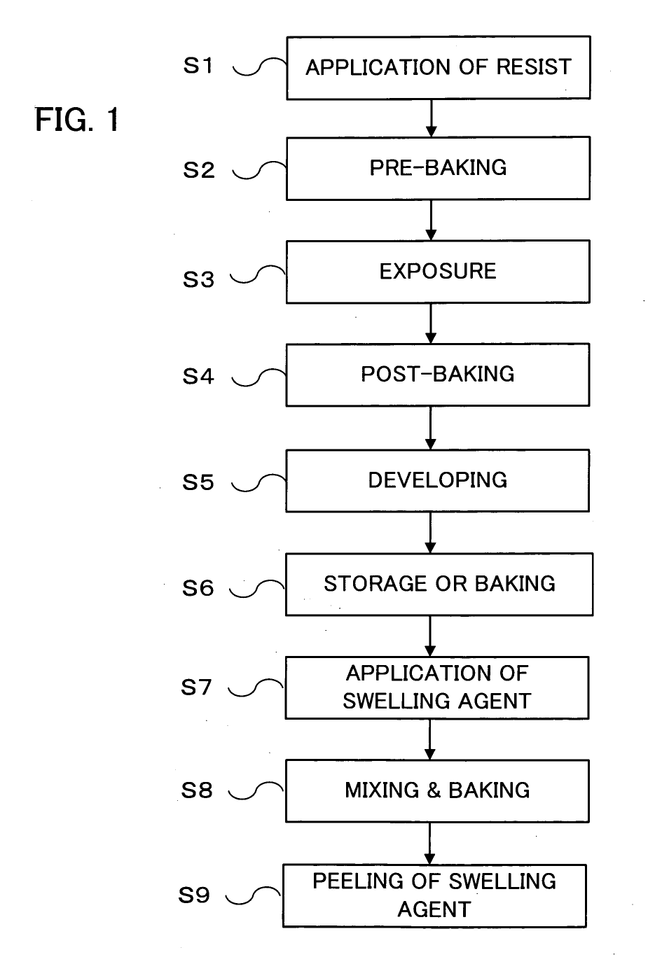

FIG. 1 exemplifies a resist pattern swelling process flow. First, a resist is applied onto a substrate (Step S1), and then the substrate is pre-baked (Step S2). Subsequently, the resist is irradiated with ArF excimer light through a pattern mask for exposure (Step S3), followed by post-baking of the substrate (Step S4). The substrate is then developed to form an unswollen resist pattern (Step S5). Subsequently, the substrate is left to stand in a cabinet to be kept in a predetermined atmosphere (this step will be hereinafter referred to as the storage step), for example, or is baked (Step S6). The substrate is then applied with a swelling agent (Step S7) and, in order to swell the resist, subjected to baking (Step S8). Finally, the applied swelling agent is peeled off (Step S9), thus obtaining a swollen resist pattern.

In this manner, the developed resist pattern is left to stand or is baked, whereby a mutual solution layer can be uniformly formed at the interface between the resist pattern and the swelling agent. This makes it possible to form resist patterns reduced in CD dispersion even though the resist patterns are subjected to the swelling.

The mutual solution of the resist pattern and the swelling agent is so controlled as to be produced in a small amount. If the mutual solution is excessive and thus the amount of swelling is large, the resist pattern collapses and also the controllability of the swelling amount lowers, causing deformation of the pattern shape. Further, the CD linearity, which is dependent on the pattern width and surrounding conditions of the pattern, becomes poor.

To allow the mutual solution of the resist pattern and the swelling agent to be produced in a small amount, the concentration of the swelling agent, the film thickness, temperature, etc. are suitably controlled.

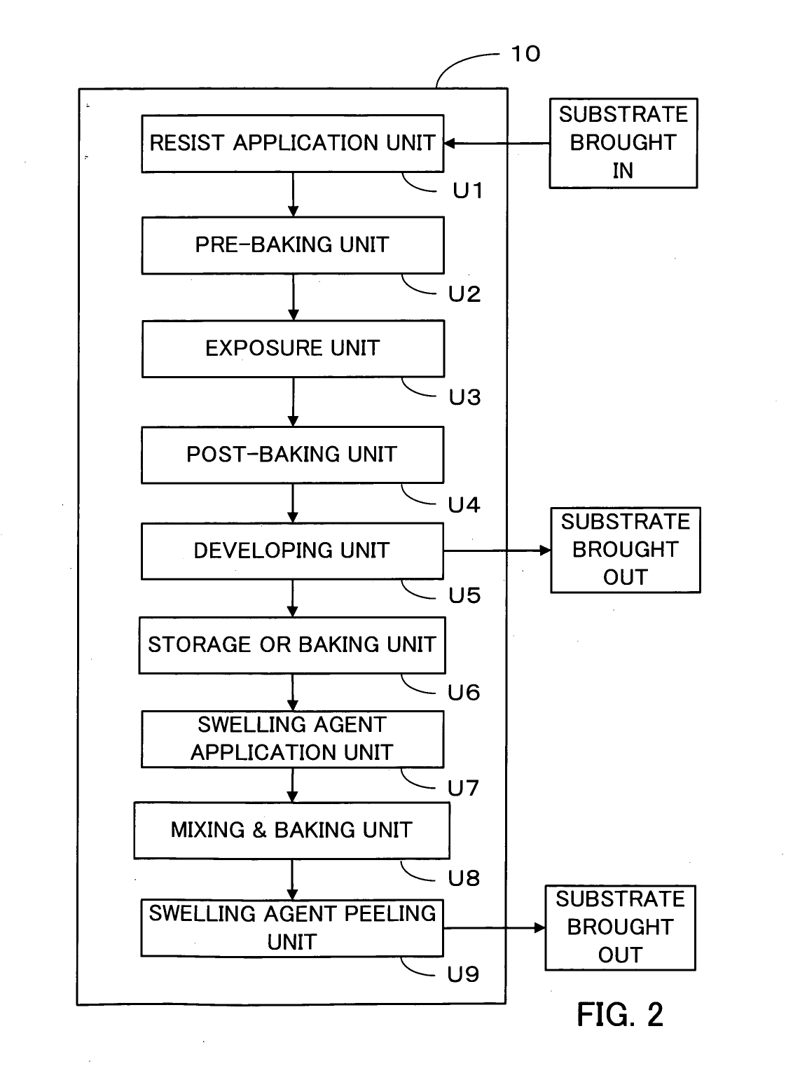

The configuration of an apparatus for swelling resist patterns will be now described. FIG. 2 shows an exemplary configuration of a resist pattern forming apparatus. First, a substrate on which a resist pattern is to be formed is brought into the resist pattern forming apparatus 10, whereupon the substrate is conveyed to a resist application unit U1 to be applied with a resist by a spin coater, for example. The substrate thus applied with the resist is conveyed to a pre-baking unit U2, where the substrate is pre-baked under predetermined conditions. After the pre-baking, the substrate is conveyed to an exposure unit U3 in which an exposure system irradiates ArF excimer light onto the resist through a pattern mask for exposure. The substrate thus exposed to the excimer light is conveyed to a post-baking unit U4 for post-baking and then conveyed to a developing unit U5, where the resist is developed to form a resist pattern which is not swollen yet. Subsequently, the substrate is conveyed to a storage or baking unit U6, where the substrate is left to stand in a cabinet at a predetermined temperature or is baked under predetermined conditions. Following the storage or baking step, the substrate is conveyed to a swelling agent application unit U7, where a swelling agent is applied onto the unswollen resist pattern by a spin coater, for example. The substrate thus applied with the swelling agent is conveyed to a mixing and baking unit U8, in which the substrate is baked under predetermined conditions to swell the resist pattern. After the swelling, the substrate is conveyed to a swelling agent peeling unit U9, where the swelling agent is removed by peeling. Then, the substrate is brought out of the resist pattern forming apparatus 10.

The resist pattern forming apparatus 10 is so configured that the developed substrate can be brought out of the developing unit U5 in cases where the swelling of the resist pattern is unnecessary.

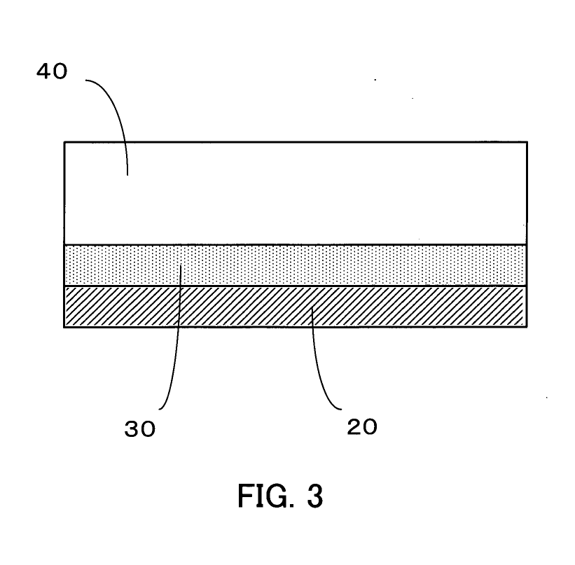

The resist pattern forming process will be now described in detail with reference to FIGS. 3 through 8, which are sectional views showing a principal part during the resist pattern swelling process.

FIG. 3 is a sectional view showing the principal part in the resist application step. First, an antireflection film 30 is formed on a Si substrate 20. Subsequently, an acrylic resin-based positive resist 40 for use with ArF excimer light is applied onto the antireflection film 30 by using a spin coater rotated at 2500 rpm (revolutions per minute). The substrate is then pre-baked at 110° C. for 120 seconds. The resist is applied to a thickness of 300 nm.

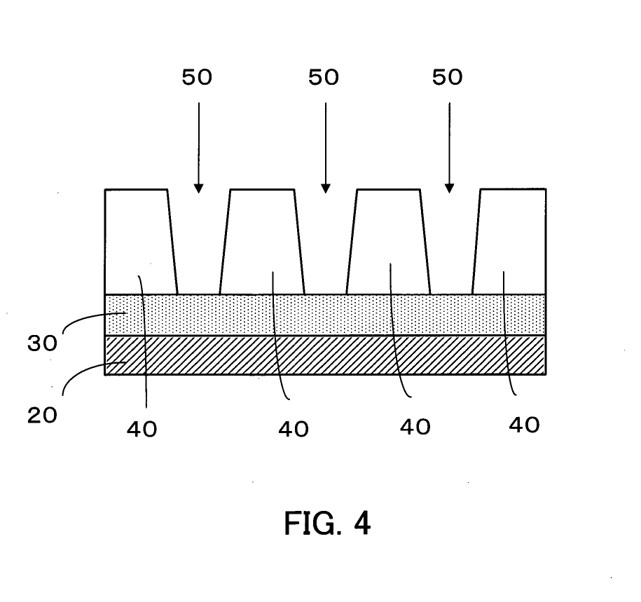

FIG. 4 is a sectional view showing the principal part in the exposure/developing step. Using an exposure mask, the mask pattern is transferred to the positive resist 40 with the exposure energy of ArF excimer light set at 400 J/m². After the exposure, the substrate is post-baked at room temperature for 90 seconds and then is developed to form a hole pattern 50 of 120 nm wide and 300 nm deep.

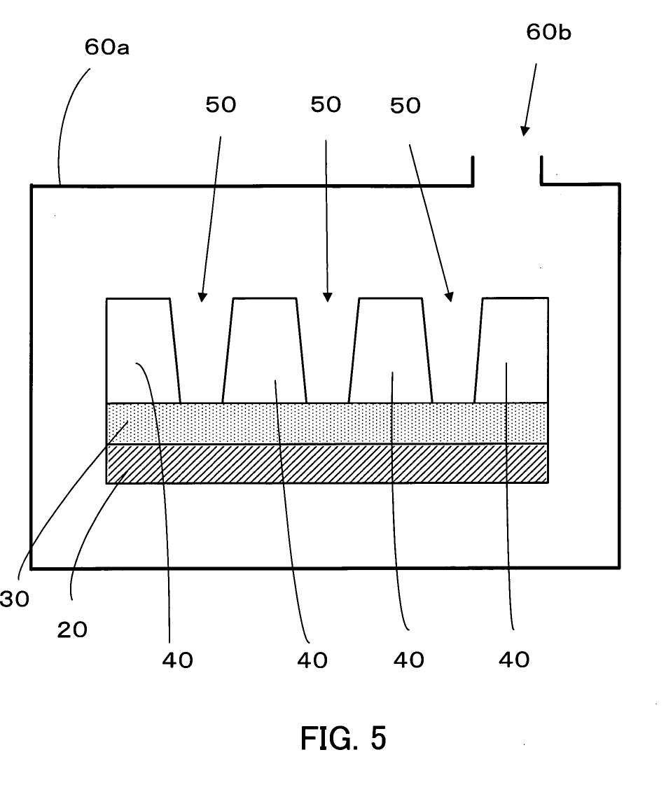

FIG. 5 is a sectional view showing the principal part in the storage step. The Si substrate 20 is placed inside a cabinet 60a and is left to stand in the air at room temperature for one hour, for example.

The resist pattern emits, from its surface, substances that contribute to the formation of a mutual solution layer, for example. Immediately after the development in particular, such substances are emitted in different amounts from different regions of the Si substrate 20. Accordingly, the storage step is conducted to allow the substances that contribute to the formation of a mutual solution layer to be discharged from an outlet 60b of the cabinet, thereby lowering the emission of the substances down to a certain stable level so that the mutual solution layer can be formed uniformly regardless of where it is located.

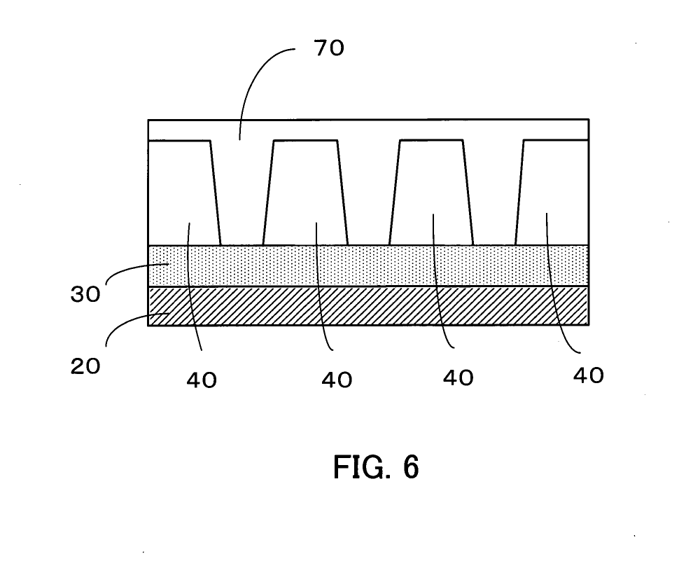

FIG. 6 is a sectional view showing the principal part in the film coating step. As the swelling agent, a solution containing a polyvinyl acetal resin, tetramethoxy methylglycoluril as a crosslinking agent, a nonionic surface active agent, pure water and isopropyl alcohol in the weight ratio of 16.0:1.16:0.25:98.6:0.4 is used, for example. Using the swelling agent, a coating 70 is formed on the antireflection film 30 and the positive resist 40 by spin coating at a rotation speed of 1500 rpm. The coating 70 is formed so as to cover the antireflection film 30 and the positive resist 40, and to this end, the thickness of the coating is adjusted so as to range from 50 nm to 100 nm both inclusive.

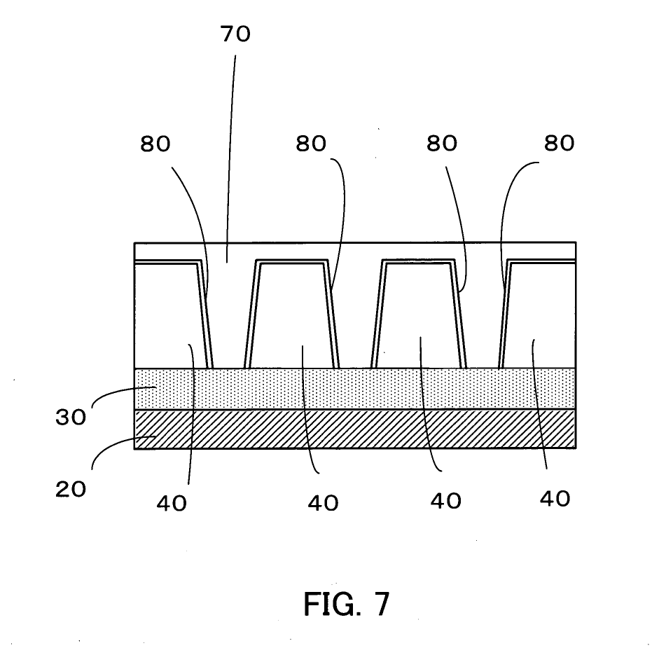

FIG. 7 is a sectional view showing the principal part in the swelling step. The substrate is baked at 90° C. for 60 seconds to swell the resist pattern. As a result, the coating 70 and the positive resist 40 dissolve in each other at their interface, forming a mutual solution layer 80. At this time, the mutual solution is produced only slightly. If the mutual solution is excessive, the contact holes are destroyed, making it impossible to form a satisfactory resist pattern. On the other hand, if no mutual solution is produced, then the resist pattern fails to swell.

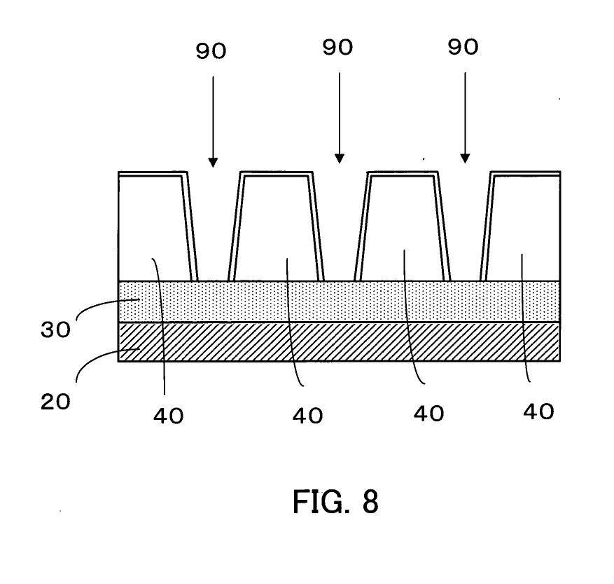

FIG. 8 is a sectional view showing the principal part in the coating peeling step. The substrate is cleaned with pure water or an aqueous alkaline solution to peel off the swelling agent, that is, the coating 70 shown in FIG. 7, thus obtaining a swollen hole pattern 90.

By following the aforementioned steps for the swelling of resist patterns, it is possible to form resist patterns reduced in CD dispersion.

The following explains the CD variation restraint effect achieved by the storage step and the CD dispersion reduction effect achieved by the restraint of CD variations.

To ascertain the effects, two sets of samples, each set included 20 substrates (Si wafers with a diameter of 200 mm), were prepared under two different conditions such that one set was subjected to the storage step while the other was not. The two conditions A and B were different from each other in the following respect.

According to the condition A, the same steps as those illustrated in FIGS. 3 through 8 were performed for the swelling of resist patterns. Namely, the condition A included the storage step in the process of swelling resist patterns. On the other hand, according to the condition B, resist patterns were swollen with only the storage step (FIG. 5) excluded from the steps illustrated in FIGS. 3 through 8.

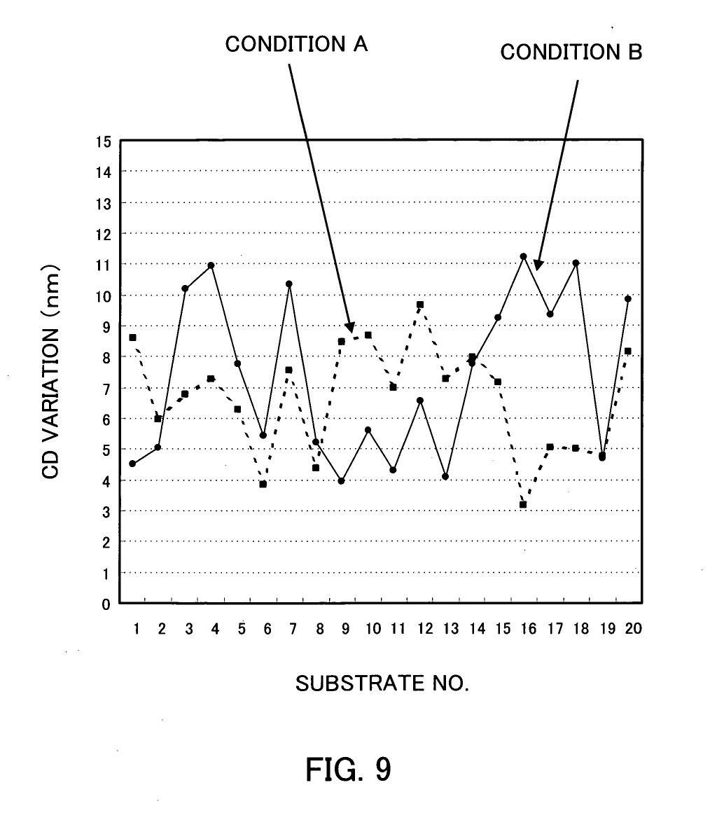

The measurement results of the samples obtained under the respective conditions will be now described. FIG. 9 shows CD variations of the individual substrates. The CD variation was derived by subtracting an after-swelling CD value from an intended CD value (120 nm). The after-swelling CD value was measured by observing a sectional image of the substrate with the use of an electron microscope. Specifically, five points on the sectional image of the substrate were observed with the electron microscope to measure CD values, and the measured CD values were averaged to obtain the after-swelling CD value.

FIG. 9 reveals that the substrates have respective different CD variations. However, the CD variations of the substrates obtained under the condition A are smaller as a whole than those of the substrates obtained under the condition B. Also, the range of dispersion is narrower in the substrates obtained under the condition A than those obtained under the condition B. The advantage of the storage step is conspicuous as explained below.

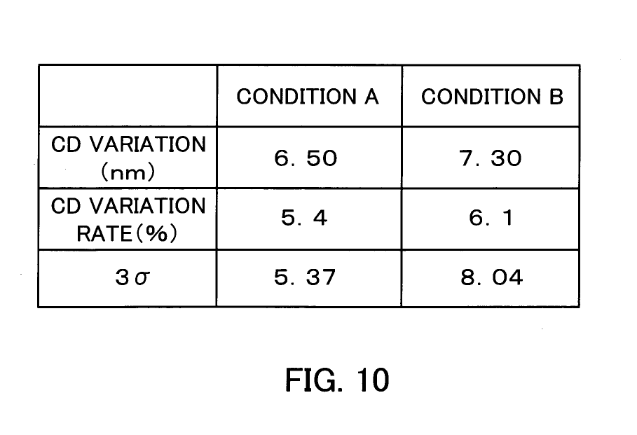

FIG. 10 shows CD variation rates and 3σ values. The CD variation rate shown in FIG. 10 is derived as the ratio of the average CD variation of the 20 substrates obtained under the individual conditions to the intended CD value. Also, the 3σ value is a threefold value of the standard deviation σ of the CD variations obtained from the 20 substrates and indicates CD value dispersion.

As seen from FIG. 10, the after-swelling CD variation rate of the substrates obtained under the condition A including the storage step is 5.4%, while the after-swelling CD variation rate of the substrates obtained under the condition B not including the storage step is 6.1%. Namely, the CD variation rate can be reduced by carrying out the storage step. Further, it is clearly shown that as the CD variation rate lowers, the 3σ value also decreases. Specifically, compared with the 3σ value of the substrates obtained under the condition B not including the storage step, the 3σ value of the substrates obtained under the condition A including the storage step is reduced by 33.2%. The CD dispersion reduction effect was obtained not only with respect to the substrates with the CD variation rate 5.4%, but with respect to other substrates which had a CD variation rate ranging from 3% to 10% and of which the resist patterns were swollen following the storage step.

In the above description, the storage step of the condition A is conducted in the air at room temperature for one hour. The CD variations, however, showed a constant value even in cases where the storage step was conducted in the air for more than one hour. Namely, the CD variations are stabilized if the storage step is continued for at least a certain period of time. Thus, the storage step permits the formation of uniform mutual solution layers, and after the CD variations are stabilized, the resist patterns are swollen, whereby the CD dispersion can be reduced.

Also, in the foregoing description, the storage step is performed after the development, but baking may be carried out instead of the storage step. To carry out the baking, with the internal temperature of the cabinet set in the range from 30° C. to 100° C., the substrate is kept in the cabinet for 10 minutes. If the baking temperature is 100° C. or higher, the resist excessively hardens and no mutual solution layer is formed, so that the resist pattern fails to swell. If the baking temperature is 30° C. or lower, on the other hand, the CD variations do not stabilize in 10 minutes.

Similar CD dispersion reduction effects could be obtained independent of pattern types, such as hole pattern, line-space pattern, isolated pattern, or dense pattern.

Further, in the above description, the storage step is conducted in the air for one hour, but the storage time may be shorter than one hour. By allowing the resist patterns to swell after the lapse of a time sufficient for the CD variations to assume a constant value, it is possible to reduce the CD dispersion.

Also, in the above example, the solution containing a polyvinyl acetal resin, tetramethoxy methylglycoluril as a crosslinking agent, a nonionic surface active agent, pure water and isopropyl alcohol in the weight ratio of 16.0:1.16:0.25:98.6:0.4 is used as the swelling agent, by way of example. The swelling agent to be used is not particularly limited to such a solution. The composition and constituents of the swelling agent may be suitably changed to adjust the amount of swelling.

Further, in the foregoing, adamantane-based resists and COMA-based resists are mentioned as resist materials for use with ArF excimer light, but the resist to be used is not particularly limited to these alone.

Namely, the conditions for uniformly forming mutual solution layers on substrates, for example, the storage condition and the application condition, may be suitably set as nodes are further scaled down in the future, to restrain the CD variations and thereby reduce the CD dispersion attributable to the swelling.

According to the present invention, a resist is applied onto a substrate, and then a resist pattern is formed. After the surface condition of the resist pattern is stabilized, a swelling agent is applied onto the resist pattern to allow the resist pattern to swell.

Consequently, the uniformity of mutual solution layers improves, thus making it possible to form resist patterns with reduced CD dispersion by using the resist pattern swelling technique.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A resist pattern forming method comprising the steps of:
(a) applying a resist onto a substrate;
(b) forming a resist pattern out of the resist;
(c) stabilizing surface condition of the resist pattern;
(d) applying a swelling agent onto the stabilized resist pattern; and
(e) swelling the resist pattern by using the swelling agent.

2. The resist pattern forming method according to claim 1, wherein the step (c) comprises the substep of leaving the substrate with the resist pattern to stand, thereby to stabilize the surface condition of the resist pattern.

3. The resist pattern forming method according to claim 2, wherein the substep comprises controlling a time for which the resist pattern is left to stand.

4. The resist pattern forming method according to claim 1, wherein the step (c) comprises the substep of baking the substrate with the resist pattern, to stabilize the surface condition of the resist pattern.

5. The resist pattern forming method according to claim 4, wherein the substep comprises controlling a baking temperature at which the resist pattern is baked.

6. The resist pattern forming method according to claim 5, wherein the baking temperature is controlled so as to fall within a range from 30° C. to 100° C.

7. The resist pattern forming method according to claim 1, wherein, in the step (c), the surface condition of the resist pattern is stabilized so that a CD variation before and after the step (e) may fall within a range from 3% to 10% with respect to an intended CD value.

8. A resist pattern forming apparatus comprising:
(a) means for applying a resist onto a substrate;
(b) means for forming a resist pattern out of the resist;
(c) means for stabilizing surface condition of the resist pattern;
(d) means for applying a swelling agent onto the stabilized resist pattern; and
(e) means for swelling the resist pattern by using the swelling agent.

9. The resist pattern forming apparatus according to claim 8, wherein the means (c) leaves the substrate with the resist pattern to stand, thereby to stabilize the surface condition of the resist pattern.

10. The resist pattern forming apparatus according to claim 9, wherein a time for which the resist pattern is left to stand is controlled to stabilize the surface condition of the resist pattern.

11. The resist pattern forming apparatus according to claim 8, wherein the means (c) bakes the substrate with the resist pattern, to stabilize the surface condition of the resist pattern.

12. The resist pattern forming apparatus according to claim 11, wherein a baking temperature at which the resist pattern is baked is controlled to stabilize the surface condition of the resist-pattern.

13. The resist pattern forming apparatus according to claim 12, wherein the baking temperature is controlled so as to fall within a range from 30° C. to 100° C.
